(19) United States
(12) Patent Application Publication
(10) Pub. No.: US 2009/0219607 A1
(43) Pub. Date: Sep. 3, 2009

(54) METHOD AND APPARATUS FOR ENHANCED RESOLUTION MICROSCOPY OF LIVING BIOLOGICAL NANOSTRUCTURES

(75) Inventors: Peter Saggau, Houston, TX (US); Olga Gliko, Houston, TX (US); Gaddum Duemani Reddy, Houston, TX (US)

Correspondence Address: FISH & RICHARDSON P.C., P.O BOX 1022, Minneapolis, MN, 55440-1022, US

(73) Assignee: Baylor College of Medicine, Houston, TX (US)

(21) Appl. No.: 12/356,721

(22) Filed: Jan. 21, 2009

Related U.S. Application Data
(60) Provisional application No. 61/021,755, filed on Jan. 17, 2008.

(51) Int. Cl. G02F 1/33

(52) U.S. Cl. 359/305

(57) ABSTRACT

The present invention is a method and apparatus that utilizes an inertia-free diffraction mechanism to control both phase and rotation of the standing wave pattern that results in super-resolution at unparalleled imaging speeds. In some embodiments of the present inventions, AODs are utilized to control period, phase, and rotation of the SW pattern in contrast to the commonly used mechano-optical principles. This allows 2D (and 3D) super-resolution imagining at high stability and speed not limited by mechanical constraints. The present invention can be utilized, for example, for real time observations of dynamic processes in living cells.

### CROSS-REFERENCE TO RELATED PATENT APPLICATIONS

This application claims priority to: provisional U.S. Patent Application Ser. No. 61/021,755, filed on Jan. 17, 2008, entitled “Method and Apparatus for Enhanced Resolution Microscopy of Living Biological Nanostructures,” which provisional patent application is commonly assigned to the assignee of the present invention and is hereby incorporated herein by reference in its entirety for all purposes.

### BACKGROUND

1. Field of the Invention

This invention relates generally to the field of imaging. More specifically, the invention relates to a method and apparatus for high speed, three-dimensional microscopy with enhanced resolution.

2. Background of the Invention

Real time observations of dynamic processes in living cells are of increasing importance in experimental biology and have inspired the development of various noninvasive imaging techniques. One example is fluorescence-based light microscopy (fluorescence microscopy) which Applicant believes is presently the most popular technique for quantitative imaging of live specimen. The spatial resolution of such far-field microscopy is limited by the smallest possible size of a light spot produced by the focusing optics. The size of this light spot is determined by the wavelength of light and the numerical aperture of the employed objective lens. However, many subcellular structures of high research interest, such as mitochondria, endoplasmic reticulum, microtubules, and vesicles, have often sizes that are below this physical limit and thus cannot be resolved with conventional light microscopy.

Although there exist imaging techniques of significantly higher resolution than light microscopy, most of them require conditions that are hostile to living specimen, e.g., the high vacuum environment of electron microscopy. Therefore, considerable efforts have been made to increase the effective resolution of fluorescence microscopy, as it generally supports aqueous and thus physiological environments. Approaches of very different technical complexity have been taken and resulted in different levels of enhanced optical resolution. Applicant believes the most popular of these is confocal microscopy, which provides a resolution improvement of about √2. [See Pawley, J. B., “Handbook of Biological Confocal Microscopy,” 3 Ed., Springer Science, New York (2006)]. A best lateral resolution of approximately 16 nm has been achieved by stimulated emission depletion (STED) microscopy. This improvement to values well below Abbe's classical diffraction limit is achieved by STED of the fluorescent volume excited by a focused laser beam through an additional donut-shaped focus of a second laser beam at the emission wavelength. [Westphal, V., and Hell, S. W., “Nanoscale resolution in the focal plane of an optical microscope,” Phys. Rev. Lett. 94(14), 143903 (2005)]. Both techniques employ high-intensity point of illumination and thus may suffer from photo damage, which is a drawback for both approaches. In addition, STED instrumentation is highly cost intensive.

Consequently, there is a need for an improved three-dimensional imaging methods and systems.

A resolution enhancement of 2 (and greater), which is significant for many biological structures, can be achieved with by wide-field approaches known as structural illumination microscopy (SIM) [Gustafsson, M. G. L., “Surpassing the lateral resolution limit by a factor of two using structured illumination microscopy.” J. Microsc. 198(2), 82-87 (2000) (Gustafsson 2000)] and standing wave fluorescence microscopy (SWFM) [Frohn, J. T., Knapp, H. F., and Stemmer, A., “True optical resolution beyond the Rayleigh limit achieved by standing wave illumination.” Proc. Natl. Acad. Sci U.S.A. 97(13), 7232-7236 (2000) (Frohn, et al. 2000)]. Such resolution improvement is achieved by means of a periodic excitation pattern with high spatial frequencies. These patterns can be created by projecting a diffraction grating on the specimen (SIM) [Gustafson 2000; Heintzmann, R. and Cremer, C., “Laterally Modulated Excitation Microscopy: Improvement of resolution by using a diffraction grating,” Proc. SPIE, 3568, 185-196 (1999) (Heintzmann, et al. 1999)] or through interferometric schemes [Frohn 2000; Chung, E., Kim, D., and So, P. T. C. “Extended resolution wide-field optical imaging: objective-launched standing-wave total internal reflection fluorescence microscopy,” Opt. Lett. 31(7), 945-947 (2006) (Chung, et al. 2006); Gliko, O., Reddy, G. D., Anvari, B., Brownell, W. E., and Saggau, P., “Standing wave total internal reflection fluorescence microscopy to measure the size of nanostructures in living, cells.” J. Biomed. Opt., 11(6), 064013 (2006)] utilizing the objective lens for both illuminating and imaging. FIG. 1 illustrates the principle of standing wave generation with a single objective lens 104. As shown in FIG. 1, two coherent laser beams 106 and 107 are focused at the back-focal plane 105 of the objective lens 104, generating the standing wave 103 at the object plane 102 of the objective lens 104 around the optical axis 101. The enhanced resolution image is constructed from multiple images, commonly three, taken at different positions of the pattern relative to the specimen. The resolution of SWFM and SIM determined as the full width at half maximum (FWHM) of the effective point spread function (PSF) is equal to half of the period of the excitation pattern.

Since the resolution improvement of SWM is one-dimensional, i.e., normal to the interference pattern, a two-dimensional (2D) lateral resolution requires rotating the pattern relative to the specimen. This has been achieved by mechanical rotation of the projected diffraction grating [Gustafsson 2000; Heintzmann, et al. 1999] or the specimen itself [Chung, et al. 2006; Chung, E., Kim. D., Cui, Y., Kim, Y. H., and So, P. T. C., “Two-dimensional standing wave total internal reflection fluorescence microscopy: Superresolution imaging of single molecular and biological specimens.” Biophys. J., 93(5), 1747-1757 (2007) (Chung, et al. 2007)], resulting in low imaging speed insufficient for real-time imaging. In addition, the excitation pattern is shifted by mechanical adjustment of the projected grating or interferometer path length.

Consequently, there is a need for an improved three-dimensional imaging methods and systems with sufficient imaging speed for real-time imaging.

### SUMMARY OF THE INVENTION

This invention relates to methods and apparatuses for enhanced resolution microscopy.

In general, in one aspect, the invention features an imaging system that includes a light source, two programmable diffractive optical elements, a dichroic mirror, a lens, and an image acquisition device. The light source is directed at a beam splitter that can split the light from the light source to form two light beams. The two programmable diffractive optical elements are configured such that they can generate and control standing waves utilizing the two light beams. The lens defines a focal plane that is a fixed distance from the lens.

Implementations of the invention can include one or more of the following features:

The two programmable diffractive optical element can be acousto-optic deflectors.

The light source can be a laser.

The image acquisition device can be a CCD camera.

The imaging system further can include a third programmable diffractive optical element (for example, a third acousto-optic deflector). The three programmable diffractive optical elements (for example, the three acousto-optic deflectors) can be configured such that they (i) generate and control the standing waves utilizing the two light beams and (ii) provide two-dimensional control of the standing waves. In such configuration, for instance, both of the first two acousto-optic deflectors can be oriented orthogonally to the third acousto-optic deflector. Furthermore, the third acousto-optic deflector can be positioned to be employed before the beam splitter forms the two light beams.

The imaging system further can include a fourth programmable diffractive optical element (for example, a fourth acousto-optic deflector).

The four programmable diffractive optical elements (for example, the four acousto-optic deflectors) can be configured such that they (i) generate and control the standing waves utilizing the two light beams and (ii) provide two-dimensional control of the standing waves. In such configuration, for instance, both of the first two acousto-optic deflectors can be oriented orthogonally to both of the third and fourth acousto-optic deflectors (i.e., the first acousto-optic deflector is oriented orthogonally to the third acousto-optic deflector, etc.).

The four programmable diffractive optical elements (for example, the four acousto-optic deflectors) can also be configured such that they (i) generate and control the standing waves utilizing the two light beams and (ii) provide three-dimensional control of the standing waves. In such configuration, for instance, both of the first two acousto-optic deflectors can be oriented orthogonally to both of the third and fourth acousto-optic deflectors (i.e., the first acousto-optic deflector is oriented orthogonally to the third acousto-optic deflector, etc.). Furthermore, one of the acousto-optic deflectors (such as the third acousto-optic deflectors) can be positioned to be employed before the beam splitter forms the two light beams.

In general, in another aspect, the invention features a method that includes splitting a initial light beam with a beam splitter to form two light beams. The method further includes directing each of the two light beams to two programmable diffractive optical elements (i.e., one light beam to one programmable diffractive optical element and the other light beam to another programmable diffractive optical element). The method further includes using the two light beams (i) to scan the back-focal plane of at least one objective lens and (ii) to control the phase and orientation of standing waves. The method further includes acquiring images collected by the objective lens using an image acquisition device.

Implementations of the invention can include one or more of the features listed above, as well as the following features:

The two programmable diffractive optical element can be acousto-optic deflectors.

The method can include passing the light beam through a third programmable diffractive optical element (i.e., a third acousto-optic deflector) before the beam splitter to control the phase and orientation of the standing waves. Such method can also include (i) utilizing the three acousto-optic deflectors to control the phase and orientation of the standing waves to obtain a two-dimensional image and (ii) reconstructing the two-dimensional image using the images acquired.

The method can also include passing the light beam through third and fourth programmable diffractive optical elements (i.e., a third and fourth acousto-optic deflectors) to control the phase and orientation of the standing waves.

Such method can also include (i) utilizing the four acousto-optic deflectors to control the phase and orientation of the standing waves to obtain a two-dimensional image and (ii) reconstructing the two-dimensional image using the images acquired.

Such method can also include passing the light beam through the third programmable diffractive optical element (i.e., a third acousto-optic deflector) before the beam splitter. Such method can further include (i) utilizing the four acousto-optic deflectors to control the phase and orientation of the standing waves to obtain a three-dimensional image and (ii) reconstructing the three-dimensional image using the images acquired.

The method can include electronically controlling the acousto-optic deflectors.

The method can include using the acousto-optic deflectors to control the penetration depth of the standing waves.

The method can include that the initial light beam has a wavelength ranging from about 300 nm to about 1000 nm.

The method can include using the acousto-optic deflectors to laterally position the two light beams in the back focal plane.

In general, in another aspect, the invention features a microscopy system that includes a light source (for generating a light beam), a back focal plane scanner, a microscope, and an image acquisition device. The back focal plane scanner includes a beam conditioner, a scanner (including three acousto-optic deflectors), and a scanner control. The microscope includes a dichroic mirror and a lens.

Implementations of the invention can include one or more of the features listed above, as well as the following features:

The scanner can be a dual scanner or a triple scanner.

The system can include a beam splitter that is positioned to split the light from the light source to form two (or more) light beams.

One of the acousto-optic deflectors (such as the third acousto-optic deflector) can be positioned to be employed before the beam splitter. The other acousto-optic deflectors (such as the first two acousto-optic deflectors) can be positioned to be employed after the beam splitter. Such acousto-optic deflectors can be configured (i) to generate and control standing waves utilizing the two light beams and (ii) to provide two-dimensional control of the standing waves.

The system can include a fourth acousto-optic deflector with all four of the acousto-optic deflectors positioned to be employed after the beam splitter. Such acousto-optic deflectors can be configured (i) to generate and control standing waves utilizing the two light beams and (ii) to provide two-dimensional control of the standing waves.

The system can include a fourth acousto-optic deflector with one of the acousto-optic deflectors (such as the third acousto-optic deflector) positioned to be employed before the beam splitter. The other acousto-optic deflectors (such as the first two and the fourth acousto-optic deflectors) can be positioned to be employed after the beam splitter. Such acousto-optic deflectors can be configured (i) to generate and control standing waves utilizing the two light beams and (ii) to provide three-dimensional control of the standing waves.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates the principle of standing wave generation with a single objective lens;

FIG. 2 illustrates an acousto-optic device (AOD) for use with embodiments of the present invention;

FIG. 3 illustrates a scheme of a 1D SWM with AODs;

FIG. 4A illustrates a 2D scanner using two AODs;

FIG. 4B illustrates the back focal plane of the 2D scanner of FIG. 4A;

FIG. 5 illustrates a schematic of a 2D SWFM;

FIG. 6 illustrates a schematic of another 2D SWFM;

FIG. 7A illustrates a standing wave total internal reflection fluorescence microscope (SW-TIRFM);

FIG. 7B illustrates the objective lens of the SW-TIRFM illustrated in FIG. 7A;

FIG. 8 illustrates the excitation pattern of the beams at the object plane of the SW-TIRFM of FIG. 7A;

FIG. 9 illustrates standing waves at different phase shifts;

FIGS. 10A-C illustrate 3D resolution enhancement of SWFM;

FIG. 11 illustrates a schematic of a 3D SWFM;

FIG. 12 illustrates a 3D super-resolution microscopy system;

FIG. 13 illustrates the back-focal plane SW wave orientation, incident angle, and phase of a 2D SW-TIRM with AODs;

FIGS. 14A-F illustrate results of standing wave microscopy of fluorescent nanobeads using 1D SWM;

FIGS. 15A-C illustrate results of standing wave microscopy of nanotubes using 1D SWM;

FIG. 16 illustrates standing wave patterns using acousto-optic deflectors;

FIGS. 17A-F illustrate results of standing wave microscopy of fluorescent nanobeads using 2D SWM;

FIGS. 18A-I illustrate results of another standing wave microscopy of fluorescent nanobeads using 2D SWM; and

FIGS. 19A-C illustrate results of a third standing wave microscopy of fluorescent nanobeads using 2D SWM.

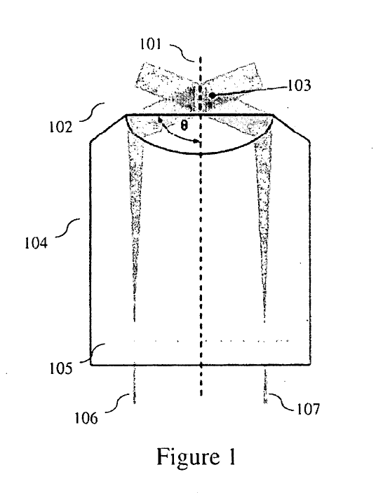

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The present invention is a method and apparatus that utilizes an inertia-free diffraction mechanism to control both phase and rotation of the standing wave pattern that results in super-resolution at unparalleled imaging speeds. In some embodiments of the present invention, AODs are utilized to control period, phase, and rotation of the SW pattern in contrast to the commonly used mechano-optical principles. This allows 2D (and 3D) super-resolution imaging at high stability and speed not limited by mechanical constraints.

While the making and/or using of various embodiments of the present invention are discussed below, it should be appreciated that the present invention provides many applicable inventive concepts that may be embodied in a variety of specific contexts. The specific embodiments discussed herein are merely illustrative of specific ways to make and/or use the invention and are not intended to delimit the scope of the invention.

The present invention utilizes programmable diffractive optical elements (DOEs) for controlling phase and orientation of standing waves (SWs) in contrast to the commonly used mechano-optical principles. The present invention makes use of the diffraction of light at an optical grating induced by high frequency sound waves propagating through a refractive medium. [See e.g., Milton, G., Ireland, C. L. M., and Ley, J. M., “Electro-optic and Acousto-optic Scanning and Deflection, Optical Engineering, Vol. 3, Marcel Dekker (1983); Xu, J. and Stroud, R., “Acousto-optic Devices: Principles, Design and Applications, John Wiley and Sons, New York (1992)]. A high speed microscope with three-dimensional laser beam scanning that included an acousto-optic deflector for controlling the lateral position and collimation or the light Beam was disclosed and taught in U.S. Pat. No. 7,227,127, issued Jun. 5, 2007 to Peter Saggau, et al., which patent is incorporated herein by reference in its entirety for all purposes.

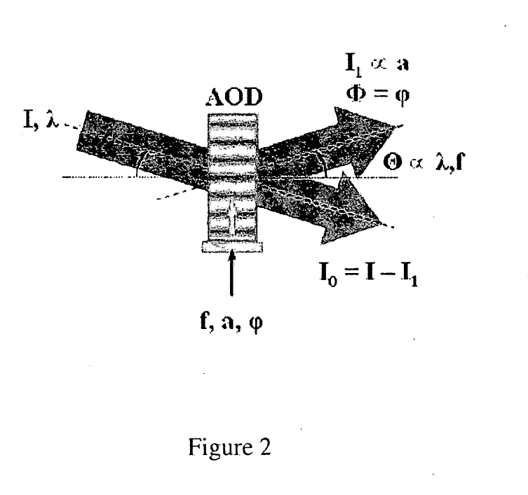

FIG. 2 illustrates an acousto-optic device for use with embodiments of the present invention. As illustrated in FIG. 2, properties of the defracted light can be independently controlled with such an acousto-optic device (AOD), such as angle, amplitude, frequency, and phase. For an AOD operating in the Bragg regime, the diffraction angle Θ is proportional to the frequency f of the sound, the diffracted first order intensity I₁ depends on the sound amplitude a, the frequency of the light v is shifted by ±f, depending on moving direction of the sound wave with respect to the incident beam, and the phase of the diffracted beam φ is directly related to the phase of the sound φ. The response time of the AODs is in the low microsecond range, depending on the laser beam diameter and the acoustic velocity. This is equal to the time required for the acoustic wave to fill the active AOD aperture (approximately 1 μs for a laser beam with a diameter of 1 mm.) These features make AODs suited to rapidly shaped wave fronts including both phase and orientation of SWs by scanning the back focal plane (BFP) of the objective lens.

### One-Dimensional Standing Wave Microscopy (1D SWM)

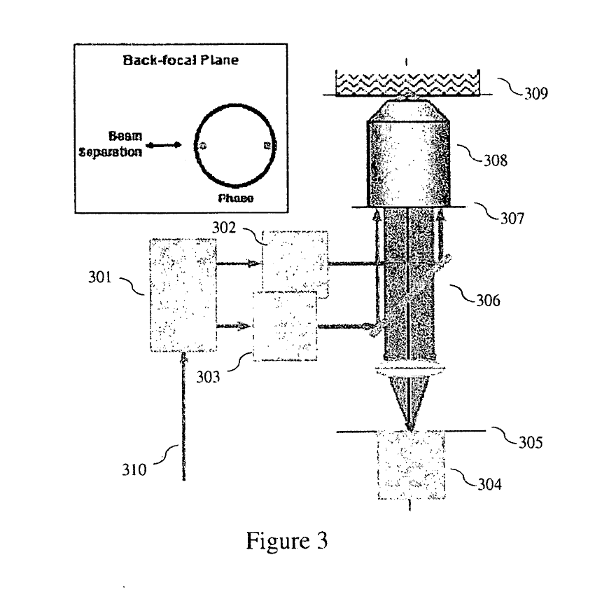

FIG. 3 illustrates a scheme of a 1D SWM with acousto-optic devices (AODs), which includes beam splitter 301, a pair of AODs (x₁AOD 302 and x₂AOD 303), a dichroic mirror 306, an objective lens 308 (having an object plane 309 and a back-focal plane 307), and a CCD camera 304 (or other image acquisition device, which can also be referred to as a detector unit) having an image plane 305. As reflected in this FIG. 3, a collimated laser beam 310 is split by the beam splitter 301 and each of the beams is deflected by one of the AODs (x₁AOD 302 and x₂AOD 303). The beams are then focused at the back focal plane 307 of the objective lens 308. An enlarged image is captured with the CCD camera 304 (which is generally a cooled CCD camera) or other detector unit.

The delay for shifting the phase of the SW is approximately 1000 times shorter than by moving a mirror with a fast piezo actuator, i.e., microseconds instead of milliseconds. This maximizes the ratio of imaging time to SW adjustment and increases the imaging speed. Also, since the phase is electronically controlled and no optical components are required to be moved, mechanical artifacts are excluded. Additionally, utilizing two AODs provides the ability to laterally position the focused laser beams in the back focal plane 307 of the objective lens 308. This provides the ability to achieve the smallest possible fringe spacing Δs by electronically matching the beam separation to the physical size of the back focal aperture.

### Two-Dimensional Standing Wave Microscopy (2D SWM)

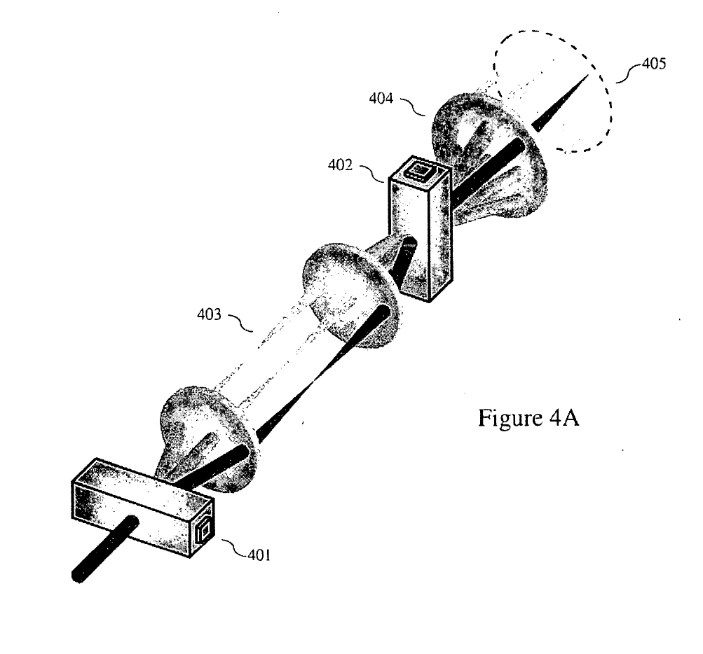

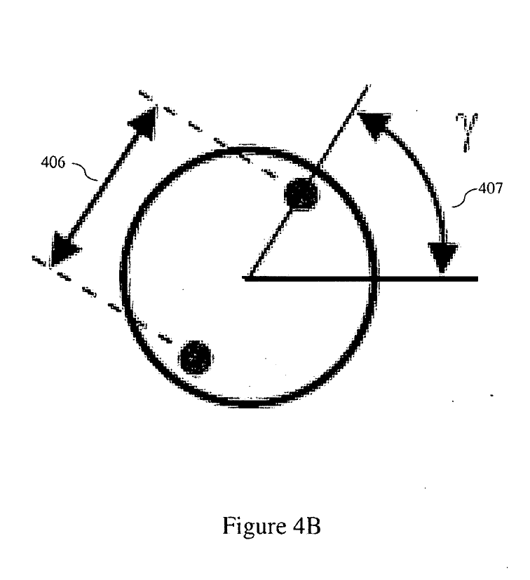

FIG. 4A illustrates a 2D scanner 403 having two AODs (xAOD 401 and yAOD 402), which are oriented orthogonally and focused at the back focal plane 405 of the objective lens by a focusing lens 404. When the laser beam passes through two orthogonally oriented AODs (such as (xAOD 401 and yAOD 402), the beam is deflected in two dimensions. The deflection angle is determine by two acoustic frequencies fₓ and f_{y} of xAOD 401 and yAOD 402, respectively.

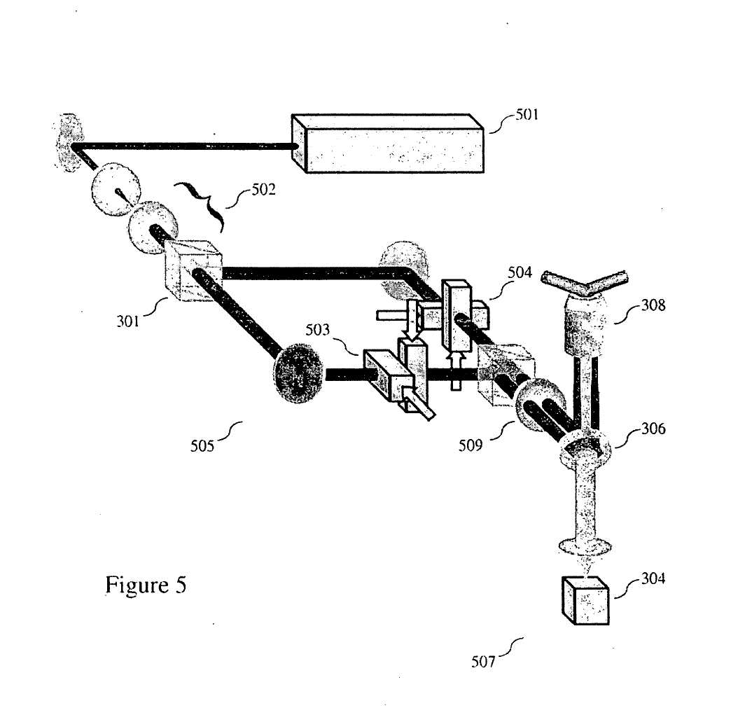

In embodiments of the present invention, two 2D scanners 403 (such as shown in FIG. 4A) can be utilized, such as in the two-dimensional standing wave fluorescence microscopy (2D SWFM) illustrated in FIG. 5. (In FIG. 5, the two 2D scanners are illustrated at x/yAODs 503 and x/yAODs 504). Each of the two beams deflected by a pair of AOD is focused at the back focal plane 405 of the objective lens by a focusing lens 404. The position of each beam at the back local plane is determined by two frequencies fₓ=f_{c}+Δf·cos γ and f_{y}=f_{c}+f·sin γ, where f_{c} is center frequency of the AOD, Δf determines beam separation, an γ is the angular orientation of the beam. FIG. 4B illustrates the back focal plane of the 2D scanner of FIG. 4A, and indicates the beam separation 406 and the beam orientation (γ) 407.

As shown in FIG. 5, one embodiment of the present invention includes two 2D scanners integrated into a interferometer 505 (such as a Mach-Zehnder interferometer). A laser beam (488 nm) from laser 501 was expanded by a beam expander 502 and divided by a non-polarizing beam splitter 301. Each of the beams passed through a pair of orthogonally oriented AODs (LS110A-XY, Isomet), which are x/yAODs 503 and x/yAODs 504. Optionally, the pair of orthogonally oriented AODs can be mounted together in one housing.

The AODs in the present embodiment were driven by RI frequency signals (such as about 80 to about 120 MHz) generated by direct digital synthesis (DDS) boards (AD9958, Analog Devices) and amplified by RF power amplifiers (DA134-2-100, Isomet). Optionally, spatial filters and mirrors (not shown) can be used to block the zero order beams and to align the deflected beams after passing through the AODs (x/yAODs 503 and x/yAODs 504). Both beams were combined by a second beam splitter and focused by a lens 509 at the back focal plane of an oil immersion 100× objective lens with NA 1.45. This resulted in two collimated beams that interfered at the local plane, creating a lateral periodic excitation pattern with adjustable fringe spacing and angular orientation. Both beams were circularly polarized by two polarizers (not shown) placed in front of the AODs. This resulted in slightly lower pattern contrast in comparison with s-polarized interfering beams.

This scheme can be used to avoid the mechanically (and therefore slow) rotation of polarizers to adjust polarization during the pattern rotation. The position of each beam a the back focal plane is determined by the two frequencies fₓ and f_{y}. The frequency of each beam after being deflected by two AODs is shifted to ν=ν₀+fₓ+f_{y}, where ν₀ is the frequency of the laser light. The point of symmetry of beam positions at the back local plane allows, optionally, the application of the same fₓ and f_{y}, fₓ≠f_{y}) to corresponding AODs, which results in the same shifted frequency v of both beams, which allows formation of the SW. The beam separation at the back focal plane determined the incident angle Θ and the SW period Δs=λₑₓ/(2n_{glass} sin Θ), where λₑₓ is the excitation wavelength, and n_{glass} is the refractive index of the glass (which was 1.52). The angular beam orientation γ at the back focal plane determines SW pattern orientation at the object plane. By adjusting the phase delay between the x/yAODs 503 and x/yAODs 504 RF signals, the SW phase can be controlled.

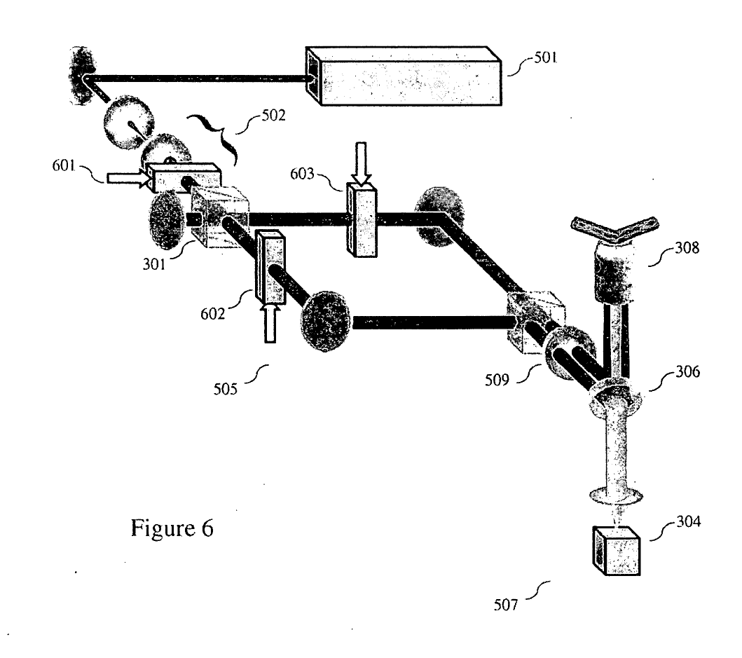

The 2D SWFM of FIG. 5 employs four AODs. As reflected in FIG. 6, the number of AODS can optionally be reduced from four to three utilizing the axial symmetry of the back focal plane illumination.

As illustrated in FIG. 6, the first of the three AODs (xAOD 601) is employed before the laser beam from laser 501 is split at beam splitter 301. After the laser beam is split at beam splitter 301, yAOD₁ 602 and yAOD₂ 603 are respectively employed for each of the beams.

This flexible AOD-based approach allows combining SWFM with total internal reflection fluorescence microscopy (TIRFM). Switching from SWFM to SW-TIRFM is achieved by adjusting the incident angle above the critical angle, Θ_{c}=61.2° by controlling the beam separation at the back focal plane. SW-TIRM allows axial selectivity (<100 nm) in addition to improved lateral movement. This technique can provide a real-time imaging of the subresolution structures in live biological specimens near the glass/water interface.

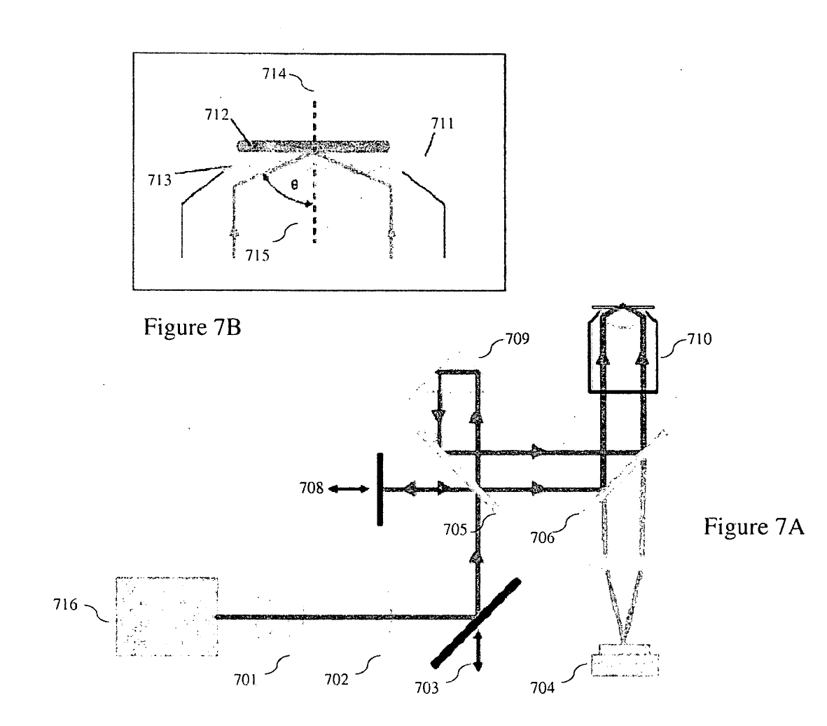

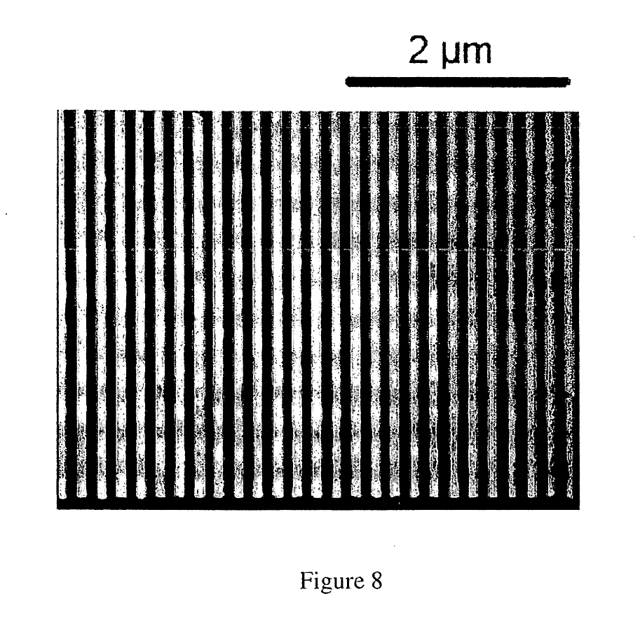

FIG. 7A illustrates an exemplary optical layout of an embodiment of a Standing Wave Total Internal Reflection Fluorescence Microscope (SW-TIRFM), which is different from known schemes. Laser light (488 nm) from laser 716 was expanded (beam expander 701) and coupled into an objective lens 710 (further shown in FIG. 7B) of a standard inverted microscope. As with embodiments in FIGS. 3, 5, and 6, the use of the inverted microscope scheme simplified both the optical system and the experimental procedure. A specimen 712 was placed in a standard Petri dish equipped with a glass coverslip bottom 711, which allowed convenient electrophysiological recording and media replacement. A SW pattern was created by using a Michelson interferometer scheme. The optical layout of this interferometer was such that it resulted in two parallel beams (beam splitter 705) with controllable separation (mirror 703) and phase shift (mirror 708). A prism 709 was also utilized. The beams were reflected by a dichroic mirror 706, and focused by a lens focusing 702 at the back focal plane of an oil immersion 100× objective lens 710 with a high NA of 1.45. (Oil immersion 713 is illustrated in FIG. 7B). This procedure resulted in two collimated beams polarized normal to the incident plane. These beams interfered at the object plane, creating a lateral periodic excitation pattern with closely spaced fringes, which is shown in FIG. 8 (standing waves at object plane).

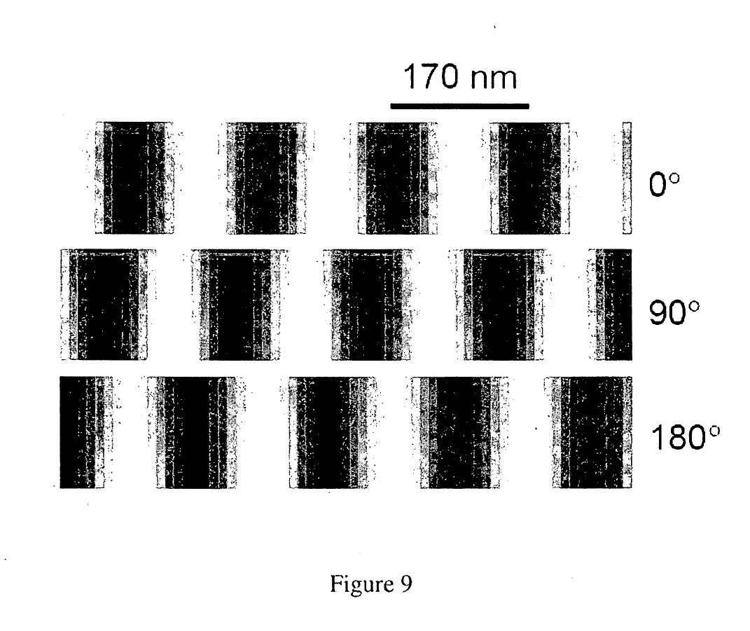

The modulated excitation pattern caused fluorescent emission, which was intensity-modulated with the same period as the excitation field. The fluorescence emitted by the specimen was collected by the same objective lens 710 and passed through the dichroic mirror 706 and an additional long-pass filter (not shown) to block residual excitation light. The fluorescence image was then magnified and captured with a cooled CCD camera 704. The phase of the SW pattern (FIG. 9) was precisely controlled by moving the piezo-actuated mirror 708. The image acquisition sequence of the camera 704 was synchronized by the computer-controlled movement of mirror 708. Data collection involved acquiring one image for each of three different phases φ, φ+90°, φ+180° of the excitation pattern (i.e. at three different fringe positions relative to the specimen). The SWM reconstructed image was calculated as the sum of the three acquired images weighted by sinusoidal factors that depend on the period and phase of the standing wave. The resulting SWM image had an enhanced lateral resolution equal to half the fringe spacing in the direction normal to the interference fringes. The maximum achievable resolution depends on the angle of beam interaction and was calculated to be 84 nm in TIR (total internal reflection) mode and 92 nm in non-TIR mode.

### Three-Dimensional Standing Wave Microscopy (3D SWM)

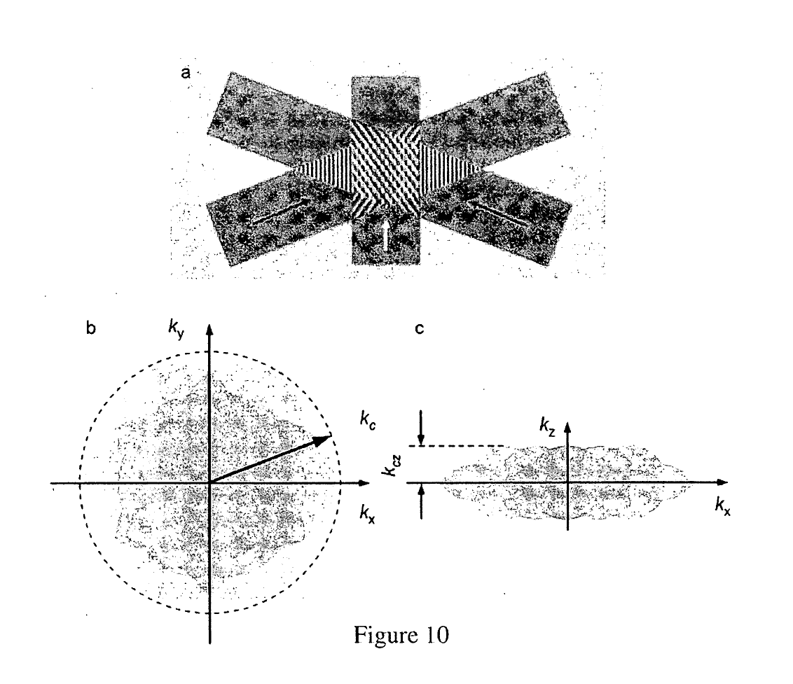

To achieve enhanced resolution in three dimensions, the SW pattern has to be extended in an axial direction. [Frohn. J. T., Knapp, H. F., and Stemmer, A., “Three-dimensional resolution enhancement in fluorescence microscopy by harmonic excitation.” Opt. Lett. 26(11) 828-830 (2001)]. One mechanism to accomplish this is to introduce a third coherent focused laser beam at the center of the back focal plane. This extra laser focus, together with the two lateral, axially symmetrical foci employed for 2D SWs (such as reflected in FIGS. 5 and 6) result in a complex 3D interference pattern such as shown in FIG. 10A. FIGS. 10B and 10C show schematic representations of the effective optical transfer function (OTF) passband region obtained by 3D SWFM. The effective passband can include the central region corresponded to standard fluorescence microscopy, 6 additional copies of the central region shifted in x/y and 12 copies shifted in x/y/z. 3D imaging involves axial scanning of the specimen and acquiring 15 raw images per section. The effective resolution improvement on a reconstructed image is twofold in both lateral and axial directions.

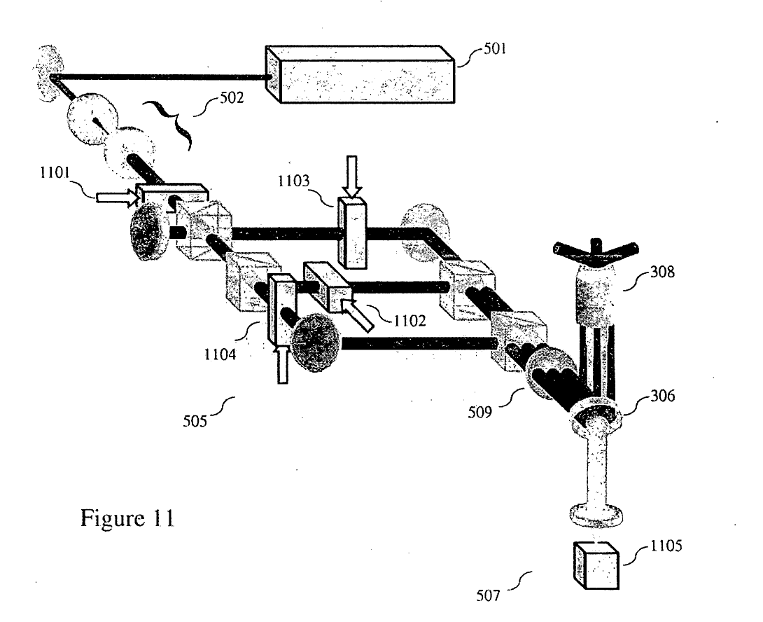

The 2D SWFM illustrated in FIG. 6 can be expanded to support the additional central non-scanning beam, which 3D SWFM is illustrated in FIG. 11. As illustrated in FIG. 11, the 3D SWFM uses four AODs, which are two shared x deflectors/frequency shifters (xAOD 1101 and x*AOD 1102) are two y deflectors (yAOD₁ 1103 and yAOD₂ 1104). Three, deflected beams are focused on the back-focal plane of the objective lens 308 and excite a specimen with a complex SW pattern. As for the detector unit 507, in alternative to a CCD camera, a highly sensitive and fast electron multiplying charge coupled device (EMCCD) camera 1105 may be coupled to the microscope with optics that provide appropriate secondary magnification.

In order to allow for SW formation, the frequency of the central beam is matched to the equally frequency shifted lateral beams. The design of FIG. 11 (which includes the 4 AODs) utilizes the axial symmetry of the scan pattern and the fact that AODs can support multiple acoustic waves and consequently generate multiple simultaneous deflected beams. Different from the 2D SWFM of FIG. 6, in 3D SWFM, xAOD 1101 is supplied in addition to fₓ with (fₓ+f_{y})/2 frequency. The additional x*AOD 1102 only receives (fₓ+f_{y})2 and is oriented such that the acoustic waves in xAOD 1101 and x*AOD 1102 counter-propagate. Slit apertures (not shown) between xAOD 1101 and both yAOD 1103 and yAOD₂ 1104 will block the (fₓ+f_{y})-beam. Similarly, the fₓ-beam is obstructed in front of x*AOD 1102. This scheme results in the desired central non-scanning third beam with a frequency shift of (fₓ+f_{y}) equal to the one of both scanning beams, thus warranting SW formation.

### Super Resolution Microscopy System

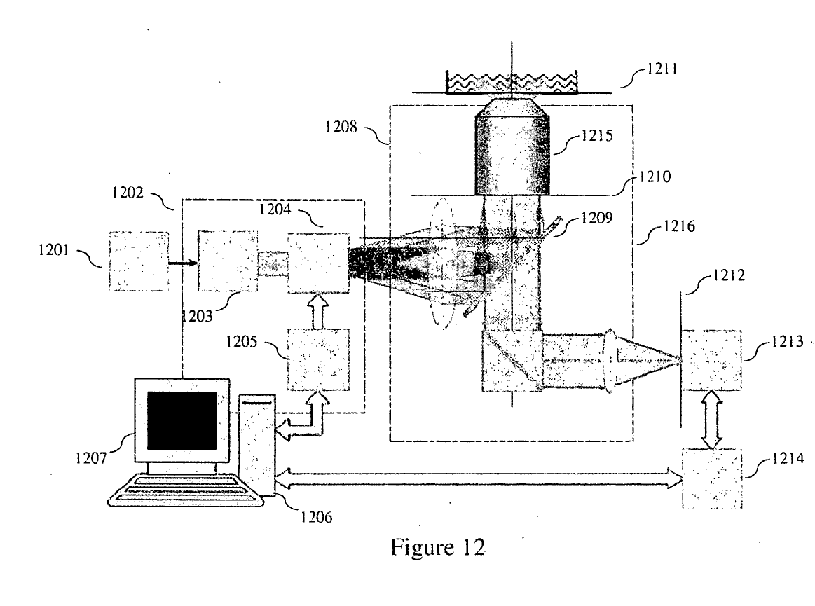

FIG. 12 illustrates a super-resolution microscopy system, and may include three units in back focal plane scanner 1202: beam conditioner 1203, dual (or triple) scanner 1204, and scanner control 1205. The system may be assembled on an optical breadboard, using an optical prototyping system that combines flexibility with stability and allows for easy enclosing of the light paths for radiation protection and wet lab use.

An optical unit such as a beam conditioner 1203 may be employed to improve the quality of the laser beam used for SW generation. This unit can also match the diameter of the laser beam (such as from CW laser 1201 illustrated in FIG. 12) to the aperture size of the AODs in order to achieve maximal resolution at the back focal plane 1210. Both beam conditioning and the use of large aperture deflectors are useful in achieving high quality SWs.

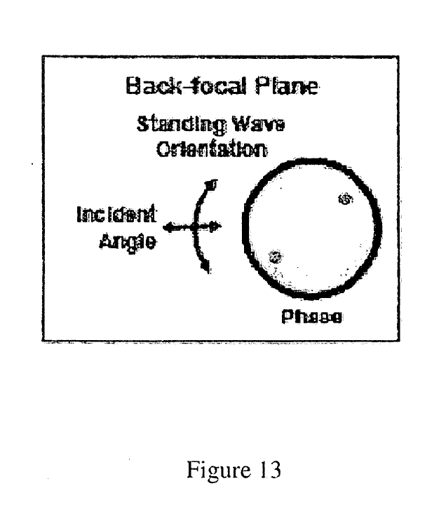

Scanner 1204 may generate two output beams from one input beam and will allow steering of the two beams with the axial symmetry shown in FIG. 13. Electronically adjustable beam parameters include: the phase delay and lateral separation between both beams, the angular orientation of the beam pair with respect to the optical axis, and the intensity of each beam.

Scanner 1204 may contain a total of three computer-controlled AODs. These DOEs can be custom-made to specification. Precision mechanical parts may be used to hold and position the AODs and appropriate telecentric coupling optics with adjustable slit apertures to obstruct unwanted secondary diffraction orders.

The AODs are electronically controlled by RF (radio frequency) signals that are transformed into acoustic waves to interact with the laser beam. This can be done utilizing the scanner control 1205. In the interferometric application, the high frequency and phase stability between the AODs is optimal, and can be easily achieved by using Direct Digital Synthesis (DDS). Since this digital technique may be used with one stable central clock for multi-channel systems, it results in frequency and phase synchrony that easily exceeds requirements.

The output of scanner 1204 may be coupled to an inverted epi-fluorescence microscope 1216. Microscope 1216 may be modified to support access to the back focal plane 1210 of the objective lens 1215 without utilizing the existing illumination path that is not suited for interferometric use such as SW generation since it would cause significant wave front distortions. The microscope 1216 further includes a dichroic mirror 1209 and has an object plane 1211 associated with the objective lens 1215). A highly sensitive and fast EMCCD (electron multiplying charge coupled device) camera 1214 (or other fast and sensitive detector unit) may be coupled to the microscope with optics that provide appropriate secondary magnification. Such magnification is favored since the pixel size of 16 μm and the objective lens magnification is 100, resulting in an effective pixels size of 160 nm. This effective pixel size is similar to the fringe spacing of the proposed system (approximately 170 nm), when using a 488 nm laser line. Therefore, a secondary magnification of approximately 10 is optimal in order to achieve sufficient lateral resolution of the phase-shifted raw images taken by the camera 1214. This magnification could also be regarded as a spatial oversampling factor of approximately 5.

FIG. 12 further shows a computer 1207 having a graphical user interface and software 1206 that is coupled to the scanner control 1205 and the camera control 1214, which are in turn coupled in the system.

### EXAMPLES

To further illustrate various illustrative embodiments of the invention, the following examples are provided.

### Example 1

### 1D SWM—Imaging of 100 nm Diameter Fluorescent Beads

The resolution of the SW-TIRFM system was tested by imaging fluorescent beads with a known diameter of 100 nm, which is below the resolution limit of standard microscopy.

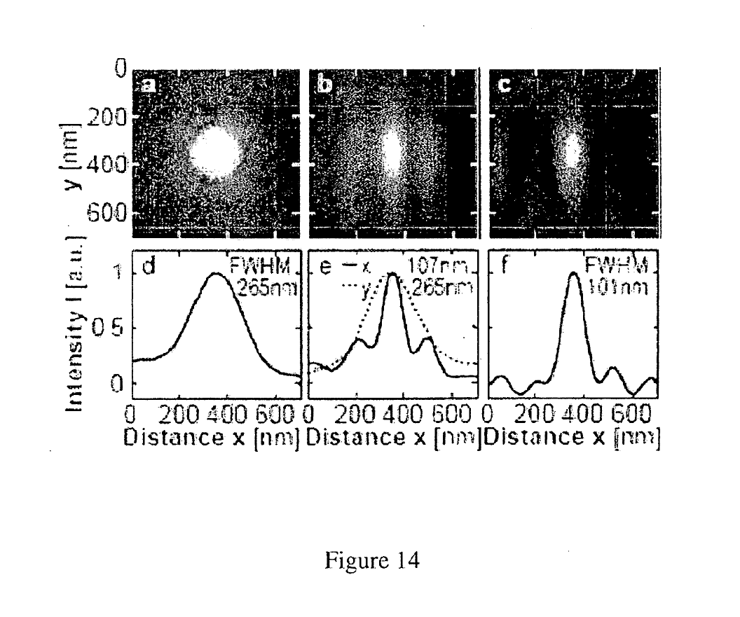

Beads suspended in water were delivered to a polylysine coated coverslip, which caused a portion of the beads to adhere to the coating. Utilizing TIR illumination improved the axial selection, which resulted in images of high contrast, with very bright beads adjacent to the glass/water interface and a dark background undisturbed by non-adhered beads. Both TIRFM and reconstructed SW-TIRFM images of the same 100 nm bead are shown in FIG. 14A and FIG. 14B, respectively. The full width at half maximum (FWHM) of the intensity profile taken of the TIRFM image was 265 nm (FIG. 14D). The intensity profiles taken in two orthogonal directions, normal and parallel to the fringes of the reconstructed SWM image (FIG. 14E) had a FWHM of approximately 100 nm (x-profile, normal direction) and 265 nm (y-profile, parallel direction), respectively. This illustrates a 1D lateral resolution improvement by a factor of greater than 2 compared to standard wide-field microscopy, as measured by the FWHM.

The resolution is enhanced in the direction normal to interference fringes. This intensity profile has two side lobes, which are intrinsic features of SWM. Such side lobes result from the convolution of an object with the effective point spread function (PSF) of SWM, which is a product of the standard PSF and excitation SW intensity. Since the side lobes were below 50% of central maximum, the object size can be unambiguously extracted by linear deconvolution. A method known as inverse-filtering [Krishnamurthi, V., Bailey, B, and Lanni, F., “Image processing in 3D standing wave fluorescence microscopy,” Proc. SPIE. 2655: 18-25 (1996)] was used as follows: the Fourier transform of the reconstructed SWFM image was divided by the effective optical transfer function (OTF) of SWM, then transformed back using only values within the bandwidth of the effective OTF. To obtain the effective PSF, the intensity profile of the TIRFM image of a 100 nm bead and the measured standing wave pattern were multiplied. The result of linear deconvolution applied to the SWM image (FIG. 14B) is shown in FIG. 14C. The corresponding intensity profile (FIG. 14F) indicated removed side lobes and a narrowed central peak compared to the x-profile in FIG. 14E. The object size can be determined from the FWHM of the intensity profile of deconvolved image. The average diameter of six beads was determined to be 101±6 nm. This illustrated that with a SW-TIRFM (such as shown in FIG. 7A), object sizes of at least 100 nm can be determined with an accuracy of 6 nm.

### Example 2

### 1-D SWM—Biological Structures (Nanotubes)

SWM vas applied to image biological nanotubes, i.e., membrane tethers between living cells. The formation of such membrane tethers is a general phenomenon that occurs during cell adhesion, communication and spreading. Previously, direct measurement of tether diameters had not been possible with light microscopy, since they are considerably below the lateral resolution limit of conventional light microscopy. Scanning electron microscopy (SEM) measurements performed on fixed cells have suggested that tethers are 50-200 nm thick [Rustom, A., Saffrich, R., Markovich, I., Walther, P., and Gerdes, H. H., “Nanotubular highways for intercellular organelle transport,” Science 303(5660):1007-1010 (2004)].

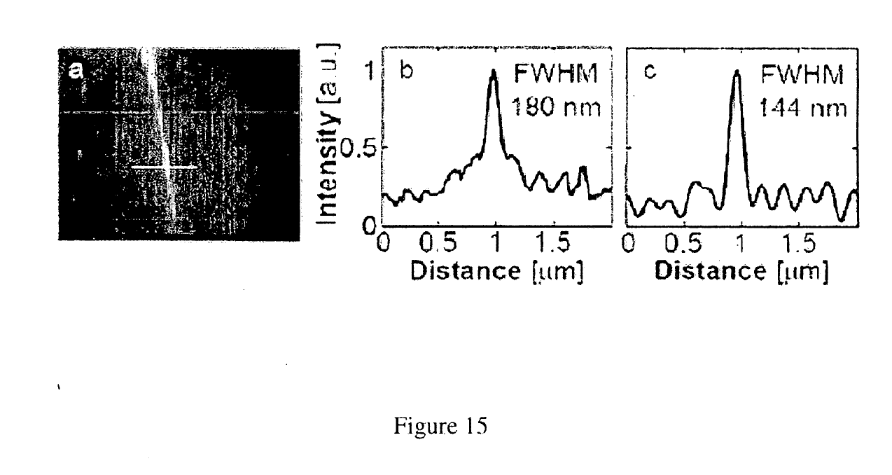

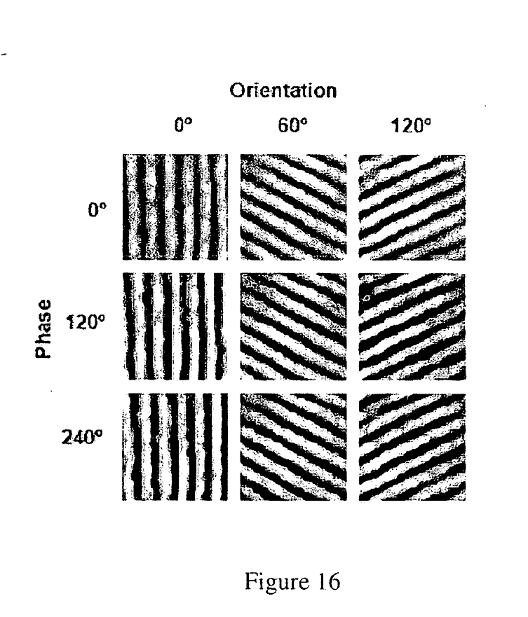

An SWM setup was used to determine the diameter of membrane tethers that formed spontaneously between cultured human embryonic kidney (HEK) cells. These tethers stretch between interconnected cells and are up to several cell diameters in length. Since most of the tethers were not close to the culture substrate, TIR was not utilized. Cell membranes were stained with the fluorescent label Alexa Fluor 488 conjugated to wheat germ agglutinin, a lectin that binds to membranes. The label was added directly to the culture medium (50 μg/ml final concentration), cells were incubated for 15 minutes, then the unbound label was washed away. The Petri dish with labeled cells was placed onto the translational stage of the inverted microscope. The diameter of the tethers oriented about parallel to the SW fringes was determined by the FWHM of the intensity profile of the deconvolved SWM image. FIG. 15A shows a typical SWM image of a tether, FIG. 15B shows the corresponding intensity profile taken along the depicted horizontal line, and FIG. 15C shows the deconvolved intensity profile. Diameters of tethers as determined by FWHM measurements were in the range from 140 nm to 270 nm. These values agree with those obtained from SEM measurements.

Applicant believes that these were the first measurements of membrane tether diameters from living cells.

### Example 3A

### 2-D SWM—Imaging of 100 nm Diameter Fluorescent Beads

An image of the specimen illuminated by the SW was formed by utilizing the 2D SWFM illustrated in FIG. 5 and was enlarged and captured by the detector unit 507, which was a cooled CCD camera 304. To obtain 2D resolution enhancement, multiple images have to be acquired while the sub-resolution structure of interest is illuminated with SW patterns of different and angular orientations. Numerical simulations indicated that three different orientations of SW pattern about optical axis are sufficient to achieve a nearly isotropic effective PSF. [See Chung, et al. 2007]. Data involved acquiring a sequence of three images at three SW phases (0°, 120°, 240°) and angular orientation (0°, 60°, 120°), resulting in a total of nine images. Preliminary results of generating and controlling nine such SW patterns with AODs are illustrated in FIG. 16.

Despite the use of large (10 mm) aperture AODs, the total time to change between the nine patterns was less than 100 μs. The acquisition speed was only limited by the time needed to collect a sufficient number of photons. When acquiring the preliminary data, the low sensitivity of the employed cooled CCD camera 304 resulted in a total acquisition time of 9 seconds. However, if a sensitive electron-multiplying camera is utilized, the total acquisition time can be about 100 times smaller, i.e., less than 100 msec. The SWFM reconstructed image was calculated using a linear algorithm similar to disclosed in Gustafsson 2000. From nine raw images, nine information components were calculated and shifted in real space by multiplying the images with the appropriate cosine functions. Then, all components were added together, divided by the effective 2D optical transfer function (OTF) in Fourier space, and transformed back to real space using only values within the bandwidth of the effective OTF. To calculate the effective OTF, the standard fluorescence image of a 100 nm bead as the PSF and the measured SW patterns were multiplied, and the product was then Fourier transformed.

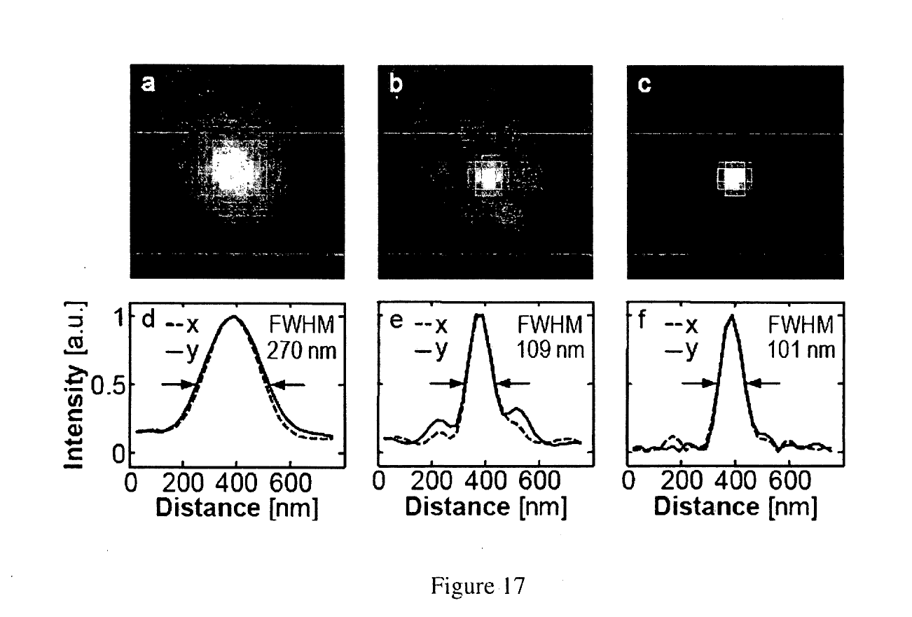

The resolution of the 2D SWFM of FIG. 5 was tested by imaging subresolution fluorescent beads with a known diameter of 100 nm. A portion of the beads suspended in water became adhered to a polysysine-coated coverslip. The incident angles of illumination beams were adjusted to provide total internal reflection (TIR) condition, which resulted in high-contrast images of adhered beads with very low background intensity. A comparison of standard fluorescence and reconstructed SWFM images of an individual bead is shown in FIG. 17A (standard fluorescence) and FIG. 17C (deconvolved SWFM images). The SWFM image reconstructed without the deconvolution is shown in FIG. 17B (SWFM). To quantify the resolution improvement, the intensity profiles were taken through the bead center along x and y directions. FIGS. 17D-F show the profiles correspond to the images in FIGS. 17A-C. The values of the FWHM were 270 nm for standard fluorescence image and 101 nm for SWFM image, which demonstrates the predicted resolution enhancement of 2D SWFM. The similarity of the achieved x and y intensity profiles of SWFM image shows a nearly isotropic effective PSF.

### Example 3B

### 2-D SWFM—Imaging of 100 nm Diameter Fluorescent Beads

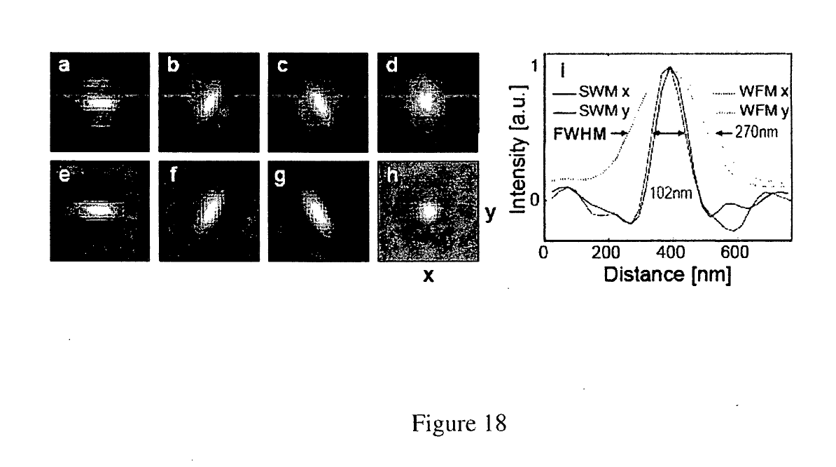

The results of imaging a different sample of 100 nm sub-resolution beads (using an 2D SWM and process similar to that described in Example 3A) is shown in FIGS. 18A-I. Images of three angular SW orientations were reconstructed from nine acquired raw images, i.e., three phases per orientation (FIGS. 18A-C). The side lobes of these intermediate images were removed by the linear deconvolution (Krishnamurthi et al. 1996). Adding the deconvolved images (FIGS. 18E-G) and subtracting the appropriately scaled sun of the nine raw images (FIG. 18D) to remove over-represented low frequency information, resulted in the desired 2D enhanced resolution (FIG. 18H).

This procedure gave a measured 2D bead size of 102 nm (FWHM, full width at half maximum), which demonstrates the predicted resolution enhancement of 2D SWM, when compared to 270 nm measured with wide-field microscopy (WFM) (FIG. 18I). The similarity of the achieved intensity profiles (SWM x,y) again indicate a nearly isotropic effective PSF.

### Example 3C

### 2-D SWM—Imaging of 100 nm Diameter Fluorescent Beads

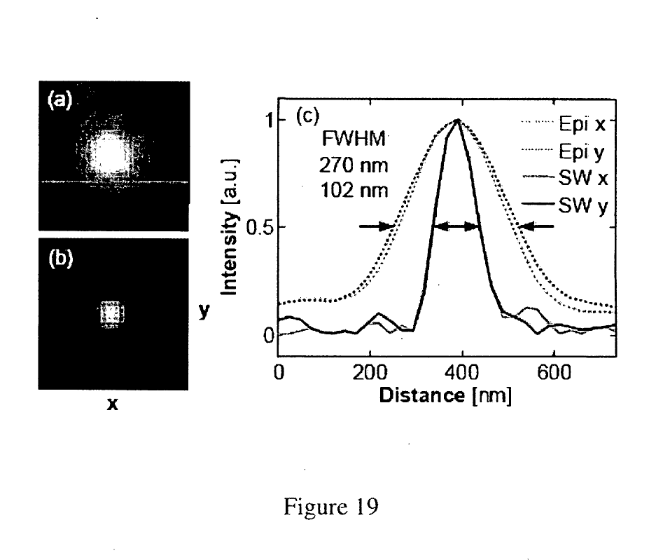

The results of imaging a different sample of 100 nm sub-resolution beads (using an 2D SWM and process similar to that described in Example 3A) is shown in FIGS. 19A-C. Again, subresolution fluorescent beads of known diameter (100 nm) were tested using the 2D SW-TIRFM of FIG. 5. A portion of the beads suspended in water became adhered to a polylysine-coated coverslip. The incident angles of illumination beams were adjusted to provide TIR condition, which resulted in high-contrast images of adhered beads with very low background intensity. A comparison of TIRF and reconstruction SW-TIRF images of an individual bead is shown in FIGS. 19A-B. To quantify the resolution improvement, the intensity profiles were taken through the bead center along x and y directions (FIG. 19C). The corresponding values of the full width at half maximum (FWHM) were 270 nm for the TIRFM image and 102 nm for the SW-TIRFM. The similarity of the achieved x and y intensity profiles of the SW-TIRFM image indicates a highly isotropic PSF.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

What is claimed is:

1. An imaging system comprising:
(a) a light source directed at a beam splitter operable to form a first light beam and a second light beam;
(b) a first programmable diffractive optical element and a second programmable diffractive optical element that are operatively coupled to the light source, wherein the first programmable diffractive optical element and the second programmable diffractive optical element are configured to generate and control standing waves utilizing the first light beam and the second light beam;
(c) a dichroic mirror operatively coupled to the first programmable diffractive optical element and the second programmable diffractive optical element;
(d) a lens which defines a focal plane that is a fixed distance from the lens, wherein the lens is operatively coupled to the dichroic mirror; and
(e) an image acquisition device operatively coupled to the lens.

2. The imaging system of claim 1, wherein
(i) the first programmable diffractive optical element is a first acousto-optic deflector, and
(ii) the second programmable diffractive optical element is a second acousto-optic deflector.

3. The imaging system of claim 2, wherein the light source is a laser.

4. The imaging system of claim 2, wherein the image acquisition device is a CCD camera.

5. The imaging system of claim 2 further comprising a third acousto-optic deflector, wherein
(i) the third acousto-optic deflector is operatively coupled to the light source,
(ii) the third acousto-optic deflector is configured to generate and control the standing waves utilizing the first light beam and the second light beams, and
(ii) the first acousto-optic deflector, the second acousto-optic deflector, and the third acousto-optic deflector are configured to provide two-dimensional control of the standing waves.

6. The imaging system of claim 5, wherein
(i) the first acousto-optic deflector is oriented orthogonally to the third acousto-optic deflector, and
(ii) the second acousto-optic deflector is oriented orthogonally to the third acousto-optic deflector.

7. The image system of claim 6, wherein the third acousto-optic deflector is positioned to be employed before the beam splitter forms the first light beam and the second light beam.

8. The image system of claim 5, further comprising a fourth acousto-optic deflector, wherein
(i) the fourth acousto-optic deflector is operatively coupled to the light source,
(ii) the fourth acousto-optic deflector is configured to generate and control the standing waves utilizing the first light beam and the second light beam, and
(iii) the first acousto-optic deflector, the second acousto-optic deflector, the third acousto-optic deflector, and the fourth acousto-optic deflector are configured to provide two-dimensional control of the standing waves.

9. The imaging system of claim 8, wherein
(i) the first acousto-optic deflector is oriented orthogonally to the third acousto-optic deflector,
(ii) the first acousto-optic deflector is oriented orthogonally to the fourth acousto-optic deflector,
(iii) the second acousto-optic deflector is oriented orthogonally to the third acousto-optic deflector, and
(iv) the second acousto-optic deflector is oriented orthogonally to the fourth acousto-optic deflector.

10. The imaging system of claim 2 further comprising a third acousto-optic deflector and a fourth acousto-optic deflector, wherein
(i) the third acousto-optic deflector and the fourth acousto-optic deflector are operatively coupled to the light source,
(ii) the third acousto-optic deflector and the fourth acousto-optic deflector are configured to generate and control the standing waves utilizing the first light beam and the second light beam, and
(iii) the first acousto-optic deflector, the second acousto-optic deflector, the third acousto-optic deflector, and the fourth acousto-optic deflector are configured to provide three-dimensional control of the standing waves.

11. The imaging system of claim 10, wherein
(i) the first acousto-optic deflector is oriented orthogonally to the third acousto-optic deflector,
(ii) the first acousto-optic deflector is oriented orthogonally to the fourth acousto-optic deflector,
(iii) the second acousto-optic deflector is oriented orthogonally to the third acousto-optic deflector, and
(iv) the second acousto-optic deflector is oriented orthogonally to the fourth acousto-optic deflector.

12. The image system of claim 11, wherein the third acousto-optic deflector is positioned to be employed before the beam splitter forms the first light beam and the second light beam.

13. An imaging method comprising:
(a) splitting a initial light beam with a beam splitter to form a first light beam and a second light beam;
(b) directing the first light beam at least a first programmable diffractive optical element;
(c) directing the second light beam to a second programmable diffractive optical element;
(b) using the first light beam directed through the first programmable diffractive optical element and the second light beam directed through the second programmable diffractive optical element to scan the back-focal plane of at least one objective lens and to control the phase and orientation of standing waves; and
(c) acquiring images collected by the objective lens using an image acquisition device.

14. The imaging method of claim 13, wherein
(i) the first programmable diffractive optical element is a first acousto-optic deflector, and
(ii) the second programmable diffractive optical element is a second acousto-optic deflector.

15. The imaging method of claim 14 further comprising passing the light beam through a third acousto-optic deflector before the beam splitter to control the phase and orientation of the standing waves.

16. The imaging method of claim 15 further comprising
(i) utilizing the first acousto-optic deflector, the second acousto-optic deflector, and the third acousto-optic deflector to control the phase and orientation of the standing waves to obtain a two-dimensional image, and
(ii) reconstructing the two-dimensional image using the images acquired during the step of acquiring images.

17. The imaging method of claim 14 further comprising
(i) passing the light beam through a third acousto-optic deflector and a fourth acousto-optic deflector to control the phase and orientation of the standing waves,
(ii) utilizing the first acousto-optic deflector, the second acousto-optic deflector, the third acousto-optic deflector, and the fourth acousto-optic deflector to control the phase and orientation of the standing waves to obtain a t-dimensional image, and
(iii) reconstructing the two-dimensional image using the images acquired during the step of acquiring images.

18. The imaging method of claim 15 further comprising
(i) passing the light beam through a fourth acousto-optic deflector to control the phase and orientation of the standing waves, wherein
(ii) utilizing the first acousto-optic deflector, the second acousto-optic deflector, the third acousto-optic deflector, and the fourth acousto-optic deflector to control the phase and orientation of the standing waves to obtain a three-dimensional image, and
(iii) reconstructing the three-dimensional image using the images acquired during the step of acquiring images.

19. The imaging method of claim 14, wherein the first acousto-optic deflector and the second acousto-optic deflector are electronically controlled.

20. The imaging method of claim 14 further comprising using the first acousto-optic deflector and the second acousto-optic deflector to control the penetration depth of the standing waves.

21. The imaging method of claim 14, wherein the initial light beam has a wavelength ranging from about 300 nm to about 1000 nm.

22. The imaging method of claim 14 further comprising using the first acousto-optic deflector and the second acousto-optic deflector to laterally position the first light beam and the second light beam in the back focal plane.

23. A microscopy system comprising:
(a) a light source for generating a light beam;
(b) a back focal plane scanner operatively coupled to the light source, wherein the back focal plane scanner comprises
(i) a beam conditioner,
(ii) a scanner operatively coupled to the beam conditioner, wherein the scanner comprises a first acousto-optic deflector, a second acousto-optic deflector, and a third acousto-optic deflector, and
(iii) a scanner control operatively coupled to the beam conditioner and the scanner;
(c) a microscope operatively coupled to the back focal plane scanner, wherein the microscope comprises
(i) a dichroic mirror, and
(ii) a lens operatively coupled to the dichroic mirror; and
(d) an image acquisition device operatively coupled to the microscope.

24. The microscopy system of claim 23, wherein
(i) the scanner is a dual scanner.
(ii) the scanner further comprises a beam splitter operatively coupled to the first acousto-optic deflector, the second acousto-optic deflector, and the third acousto-optic deflector, whereby the beam splitter is positioned to split the light from the light source to form a first light beam and a second light beam;
(iii) the third acousto-optic deflector is position to be employed before the beam splitter,
(iv) the first acousto-optic deflector and the second acousto-optic deflector are positioned to be employed after the beam splitter,
(v) the first acousto-optic deflector, the second acousto-optic deflector, and the third acousto-optic deflector are configured to generate and control standing waves utilizing the first light beam and the second light beam, and
(vi) the first acousto-optic deflector, the second acousto-optic deflector, and the third acousto-optic deflector are configured to provide two-dimensional control of the standing waves.

25. The microscopy system of claim 23, wherein
(i) the scanner is a dual scanner,
(ii) the scanner comprises a fourth acousto-optic deflector,
(iii) the scanner further comprises a beam splitter operatively coupled to the first acousto-optic deflector, the second acousto-optic deflector, the third acousto-optic deflector, and the fourth acousto-optic deflector, whereby the beam splitter is positioned to split the light from the light source to form a first light beam and a second light beam;
(iv) the first acousto-optic deflector, the second acousto-optic deflector, the third acousto-optic deflector, and the fourth acousto-optic deflector are positioned to be employed after the beam splitter,
(v) the first acousto-optic deflector, the second acousto-optic deflector, the third acousto-optic deflector, and the fourth acousto-optic deflector are configured to generate and control standing waves utilizing the first light beam and the second light beam, and
(vi) the first acousto-optic deflector, the second acousto-optic deflector, the third acousto-optic deflector, and the fourth acousto-optic deflector are configured to provide two-dimensional control of the standing waves.

26. The microscopy system of claim 23, wherein
(i) the scanner is a triple scanner,
(ii) the scanner comprises a fourth acousto-optic deflector,
(iii) the scanner further comprises a beam splitter operatively coupled to the first acousto-optic deflector, the second acousto-optic deflector, the third acousto-optic deflector, and the fourth acousto-optic deflector, whereby the beam splitter is positioned to split the light from the light source to form a first light beam and a second light beam;
(iii) the third acousto-optic deflector is position to be employed before the beam splitter,
(iv) the first acousto-optic deflector, the second-optic device, and the fourth acousto-optic deflector are positioned to be employed after the beam splitter,
(v) the first acousto-optic deflector, the second acousto-optic deflector, the third acousto-optic deflector, and the fourth acousto-optic deflector are configured to generate and control standing waves utilizing the first light beam and the second light beam, and
(vi) the first acousto-optic deflector, the second acousto-optic deflector, the third acousto-optic deflector, and the fourth acousto-optic deflector are configured to provide three-dimensional control of the standing waves.
